(19) United States
(12) Patent Application Publication
(10) Pub. No.: US 2014/0272510 A1
(43) Pub. Date: Sep. 18, 2014

(54) STRUCTURE FOR STORING MOTOR VEHICLE BATTERIES HAVING A MECHANISM FOR LOCKING THE BATTERIES IN THE STORAGE CELLS

(71) Applicants: Gilles Mulato, Chatillon (FR); Alain Bachir, Saint Germain La Grange (FR); Florent Jardel, Saint Ouen (FR)

(72) Inventors: Gilles Mulato, Chatillon (FR); Alain Bachir, Saint Germain La Grange (FR); Florent Jardel, Saint Ouen (FR)

(73) Assignee: RENAULT s.a.s., Boulogne Billancourt (FR)

(21) Appl. No.: 14/236,520

(22) PCT Filed: Jul. 30, 2012
(86) PCT No.: PCT/FR12/51795

§ 371 Date: Jun. 3, 2014

(30) Foreign Application Priority Data
Aug. 2, 2011 (FR) 11 57091

(51) Int. Cl. B60S 5/06

(52) U.S. Cl. CPC B60S 5/06
USPC 429/99; 29/825

(57) ABSTRACT

The invention relates to the installation and/or removal of a power supply battery (11) of an electric motor for driving an electric or hybrid motor vehicle in/from a storage cell (12) of a battery storage structure (10), which includes a step of actuating a locking mechanism (13) with which the storage cell is provided in order to move same between a locked state, in which the locking mechanism immobilizes, in space, the battery with which the latter engages inside the storage cell in a storage position, and an unlocked state, in which the locking mechanism frees, in space, the battery from the storage position thereof.

### TECHNICAL FIELD OF THE INVENTION

The invention relates to a method for the installation and/or removal of an energy container for supplying power to an electric drive motor of a motor vehicle of the electric or hybrid type in/from a storage cell of a storage structure for such energy containers.

The invention also relates to a storage structure for energy containers in addition to a method for exchanging and an exchange station for such energy containers implementing said storage structure, and finally a management method and a management system for a fleet of electric or hybrid motor vehicles based on said solution of exchanging energy containers.

### PRIOR ART

Some motor vehicles, such as electric or hybrid vehicles, comprise an energy container for supplying power to an electric drive motor, said container being of the battery type supplying electrical power. In the remainder of the description, the term “battery” will be used for reasons of simplicity to denote in the broad sense any container for supplying electrical power to an electric drive motor of a vehicle. It may prove expedient to exchange said battery when the power level thereof is low for a new charged-up battery. This may be carried out in an exchange station, such as for example a station similar to a service station for filling fuel tanks associated with internal combustion engines.

An exchange station for batteries supplying electrical power to an electric drive motor of an electric vehicle and a method for implementing such an exchange is disclosed in the document US 2010/145717. The exchange station disclosed comprises a lifting device provided with a means for locking and unlocking the battery on the vehicle.

A problem with implementing such a concept of exchanging batteries lies in the fact that many different types of motor vehicle exist, comprising batteries of different types and fixed in different ways to the motor vehicle. More specifically, it is not possible in terms of economics to increase the number of mounting and dismantling systems for said different types of battery nor to put in place a manual solution due to the cost thereof and the weight of the batteries. The solution disclosed in the document US 2010/145717 does not provide a satisfactory solution to this problem of flexibility relative to the solution for exchanging the battery, in particular due to a lack of robustness.

A further solution is disclosed in the document US 2008/0053716 which reveals a storage structure for batteries comprising a group of storage cells, each delimited at the top and at the bottom by shelves forming part of the structure and delimited at the right and at the left by partitions. This arrangement does not resolve the problem of flexibility as the storage cells are only suitable for a single type of battery. Moreover, this solution has the additional drawbacks of:
requiring an adaptation to position the cooling system and the electrical connections,
providing at least two stations or robots, one to ensure the dismantling or the reception of the battery at the exchange station, the other to store the batteries in the cells of the storage structure. The stations produced according to this principle thus have an exchange zone and a storage zone,
requiring a transport pallet for each battery when transporting said battery outside the exchange zone.

The structural arrangements of said cells do not permit the required volume at the station to be optimized; more specifically it is necessary to have standard sizes of cells and to provide for the passage of the storage tool (a complete aisle, for example).

### OBJECT OF THE INVENTION

To allow a simple development of the solutions for exchanging batteries, it is necessary to make the operation of said solutions reliable, robust, flexible and universal, whilst at the same time limiting the cost thereof.

The object of the present invention is to provide a solution for the storage structure for batteries and a method for the installation and/or removal of the battery in/from said structure which make it possible to remedy the problems cited above. In particular, the invention proposes a solution which is simple, reliable and robust, flexible and universal, whilst at the same time economical.

A first feature of the invention relates to a method for the installation and/or removal of a battery for supplying power to an electric drive motor of a motor vehicle of the electric or hybrid type in/from a storage cell of a battery storage structure. This method is noteworthy in that it comprises a step of actuating a locking mechanism with which the storage cell is provided in order to move said locking mechanism between a locked state spatially immobilizing the battery inside the storage cell, said locking mechanism cooperating with said battery in a storage position, and an unlocked state spatially releasing the battery from its storage position.

This method makes it possible to provide a flexible structure in which in each cell the conventional interfaces of the vehicle (locking, cooling and electrical connections) are reproduced by simply adapting the locking mechanisms with which the cells are provided according to the batteries to be stored, to provide flexibility irrespective of the type of battery and to make the solution universal. It makes it possible to dispense with the necessity of providing transport pallets for the batteries between the exchange and storage zones. Moreover, by eliminating the necessity of depositing the batteries from the front, the solution optimizes the volume of the station. Furthermore, the size of the storage cells is precisely optimized to the dimensions of the batteries to be stored, eliminating any loss of space in the storage structure, said storage cells being positioned on both sides of the exchange station and thus the passage from the exchange zone serves both for the dismantling/mounting operation on the vehicle but also the removal/installation operation on the storage cell. Said storage cells are optionally provided with a tilting system to permit the release of the locking/connecting mechanisms and cooling interfaces from the storage structure, to permit the passage of the battery into its storage position, no longer from below but transversely.

A second feature of the invention relates to a storage structure for batteries for supplying power to an electric drive motor of a motor vehicle of the electric or hybrid type, comprising a plurality of storage cells, each capable of housing a battery. Said structure is noteworthy in that each storage cell comprises a locking mechanism capable of moving between a locked state spatially immobilizing the battery inside the storage cell, said locking mechanism cooperating with said battery in a storage position, and an unlocked state spatially releasing the battery from its storage position. Said structure makes it possible to reproduce the layout of an imaginary vehicle which, during the storage and charging of the battery, enables an identical configuration to that on-board the vehicle to be identified. The exchange means has the feature of being positioned below the charging cell and locking the battery as is carried out on-board the vehicle.

The invention also relates to a method for exchanging and an exchange station for a battery supplying power to an electric drive motor of a motor vehicle of the electric or hybrid type, which are noteworthy in that they comprise a method for the installation and a method for the removal of the battery and respectively a storage structure, as mentioned above.

Finally, the invention further relates to a management method and a management system for a fleet of vehicles, noteworthy in that they respectively comprise at least one exchange of batteries of the vehicles of the fleet and a plurality of exchange stations as mentioned above.

### BRIEF DESCRIPTION OF THE DRAWINGS

Further advantages and features will emerge more clearly from the following description of particular embodiments of the invention provided by way of non-limiting examples and shown in the accompanying drawings, in which:

FIG. 1 is a perspective view of an example of the storage structure,

FIGS. 2 to 4 respectively illustrate a locking and tilting mechanism and the electrical connection elements and connecting elements with which a storage cell is provided,

FIGS. 5 and 6 show an example of an actuating tool, the lifting device and the displacement element,

FIG. 7 illustrates the elements of FIGS. 5 and 6 in a situation cooperating with the storage structure.

### DESCRIPTION OF PREFERRED EMBODIMENTS OF THE INVENTION

FIG. 1 illustrates an example of a storage structure 10 according to a feature of the invention designed to receive energy containers capable of supplying power to an electric drive motor of a motor vehicle of the electric or hybrid type. A battery 11 is visible, for example, in FIGS. 5 to 7.

Said storage structure 10 may, for example, form part of a battery exchange station, designed to permit the dismantling from a vehicle of a battery having a low level of electrical power and the installation of said battery in the structure 10 using an exchange means described below, which removes a new, charged battery from a storage cell of the structure 10 and then mounts said battery on the vehicle. However, the structure 10 may be used in any location requiring the handling of interchangeable batteries, such as for example a motor vehicle factory, a vehicle distribution network or after-sales network or even repair centers.

The storage structure 10 comprises a plurality of storage cells 12, each capable of housing a battery 11. The storage cells 12 are, for example, organized into rows and columns. In the example of FIG. 1, the structure comprises three columns, each comprising two superposed cells 12. Thus, the structure 10 comprises two superposed rows, each of three aligned cells 12. In an advantageous embodiment, not shown, the cells 12 of the same row may be mobile along said row. This possibility may even be provided so as to offer a degree of freedom of the cells 12 relative to one another. Said arrangements permit, on the one hand, a honeycomb structure 10 to be provided, said structure being modular according to the types of battery, in particular as a function of the dimensions thereof and, on the other hand, the ability to position a battery to be removed from a cell opposite an exchange means without necessarily having the need to displace said battery, in order to improve the time taken for the battery exchange cycle.

According to an essential feature, each storage cell 12 comprises a locking mechanism 13, visible separately in FIG. 2 for example, capable of moving between a locked state spatially immobilizing the battery 11 inside the storage cell 12, said locking mechanism cooperating with said battery in a storage position, and an unlocked state spatially releasing the battery 11 from its storage position. Thus the installation of a battery 11 in a storage cell 12 comprises a step of actuating the locking mechanism 13 with which the storage cell 12 is provided to move said locking mechanism from the unlocked state to the locked state for spatially immobilizing the battery inside the storage cell 12, said locking mechanism cooperating with said battery in its storage position. To achieve this actuating step, an actuating tool 14 (visible in FIGS. 5 and 6) may be used in order to maneuver the locking mechanism 13 from the storage cell 12, said maneuver being able to be carried out, for example, from below the storage cell 12. The storage structure 10 may advantageously be configured so as to provide access from below the storage cells 12 so that the maneuver of the locking mechanism 13 of a given storage cell 12 may be carried out from below the storage cell 12.

It is possible to provide tilting of the frame delimiting the cell, permitting the release thereof from the structure when stored, for example, and thus no longer requiring mounting from below but partially in a transverse manner. To this end, the frame may be provided with one or more tilting devices referenced 16 in FIG. 2.

The exchange means may be configured such that the actuating step may comprise simultaneous lifting of the actuating tool 14 and of the battery. To achieve this, the actuating tool 14 may be fixed to a lifting device 15 and configured so as to support the battery outside the zone of the storage cell 12, said lifting device 15 also being able to be mounted on a displacement element 17 configured to translate the lifting device 15 in at least one direction or in two perpendicular directions X and Y in FIG. 6. Thus, the exchange means comprises at least one actuating tool 14, the lifting device 15 and the displacement element 17. The vertical lifting direction referenced Z is at the same time perpendicular to the directions of displacement X, Y of the lifting device 15. For example, the direction Y corresponds to the direction of displacement of the lifting device 15 and thus of the actuating tool 14 to cooperate with one of the mechanisms 13 of one of the storage cells 12 (see in particular FIG. 7 which illustrates this situation where the device 15 is cantilevered inside the structure 10 relative to the displacement element 17). Trestles 20 may be provided to absorb forces to compensate for the flexion associated with the cantilevering of the means.

Advantageously, the displacement element 17 may be provided with a torsion bar configured so as to compensate for the cantilevered forces. The means may be provided with a cable system combined with the torsion system and for compensating for clearance in the system, permitting a flexibility of the locking table in the theta direction X and in the theta direction Y to achieve perfect coplanarity between the battery and the receiving surface on the vehicle.

The direction X in turn may correspond to the direction of displacement of the lifting device 15 and thus of the actuating tool 14 between the storage structure 10 and a zone for mounting and/or dismantling batteries 11 on vehicles. The combined movements of the actuating tool 14 resulting from the combined operations of the lifting device 15 and the displacement element 17 has the effect of causing a transfer of the actuating tool between the structure 10 and the zone for mounting/dismantling on the vehicle. The displacement element 17 may comprise a carriage ensuring the displacement in the direction X of a lifting table which is optionally mobile in a direction Y relative to the carriage and an element thereof, which is mobile in the direction Z using, for example, pairs of lifting forks via cables, constitutes the lifting device 15.

By way of example, having the advantage of its rapidity and its ease of implementation, the locking mechanism 13 of each storage cell 12 may be configured such that its actuation requires the tensioning of the mechanism to obtain its disengagement, then a rotation (for example of 90 degrees) of at least one lock 21 (for example four in number) to obtain the locking and/or the unlocking of the mechanism. It is also possible to provide that the actuating tool 14 is flexible in the sense that it may be adjusted or changed to be adapted to the different types of locking mechanism which the cells 12 may comprise. Finally, the exchange means comprise all of the actuators, not shown, required for the displacement, lifting and actuating operations of the locking mechanisms.

Finally, the process of removing a battery 11 from a storage cell 12 of the storage structure 10 comprises the reverse steps of those described above for the installation of the battery. Thus, the removal of a battery 11 from a storage cell 12 comprises an actuating step of the locking mechanism 13 with which the storage cell 12 is provided to cause it to pass from the locked state spatially immobilizing the battery 11 in its storage position inside the storage cell 12, said locking mechanism cooperating with said battery, into the unlocked state releasing the battery from its storage position. The battery 11 may be removed from the cell 12 by being deposited on the tool 14 which is then lowered by the lifting device 15, in order subsequently to be able to carry out the transfer of the assembly formed by the tool 14 and the battery 11 thus supported by the tool 14, using the exchange means (in particular the displacement element 17) to the zone for mounting the battery on a vehicle.

Naturally, apart from the material means disclosed above, the exchange means comprise software means permitting the material means to act in sequence to implement the described process of installation and/or removal, in a manner which is automated, monitored and reliable. The software means may, in particular, comprise computer programs located on a central controller of the battery exchange station 11.

Moreover, in a dedicated exchange station which comprises at least one storage structure 10 as cited above, it is possible to exchange a battery 11 for supplying power to an electric drive motor of a motor vehicle of the electric or hybrid type, by dismantling the discharged battery and installing said battery in the storage structure 10 in a manner described above, then removing a charged battery 11 from a cell 12 in a manner described above before transferring and mounting said battery on the vehicle once again. Said exchange station may, in particular, comprise the exchange means described above.

In one possible but non-limiting embodiment, said battery exchange may thus comprise a step of mounting and/or dismantling a battery on a vehicle in a zone dedicated to said operations, said step comprising an actuation of a locking mechanism with which the vehicle is provided in order to move said locking mechanism between a locked state fixing the battery on the vehicle and an unlocked state releasing the battery from the vehicle.

It thus becomes possible to conceive of the management of a fleet of motor vehicles of the electric or hybrid type in which at least one exchange of batteries supplying power to electric drive motors of vehicles of the fleet is implemented by applying the principle of exchange as described above. This exchange may also potentially provide for a transfer of an actuating tool of the locking mechanisms with which the vehicles and storage cells 12 are provided between the storage structure 10 and the zone for mounting and/or dismantling the battery on the vehicle. In particular, this possibility will be advantageously envisaged in the specific case where the vehicles of the fleet are configured such that the locking mechanisms with which they are provided are able to be maneuvered by the same actuating tool 14 as that which maneuvers the storage cells 12 of the storage structure 10. By way of example, the locking mechanisms with which the vehicles are provided may be identical to the locking mechanisms 13 which the storage cells 12 of the storage structures 10 of the exchange stations comprise.

This management of the fleet of motor vehicles may also be organized using a management system for said fleet comprising a plurality of such exchange stations.

Each storage cell 12 of the structure 10 may comprise electrical connection elements 18 (FIG. 4) to a circuit for electrical recharging of the battery and/or connecting elements 19 (FIG. 3) to a battery cooling circuit. Said arrangements make it possible to carry out electrical charging and thermal cooling of the batteries occupying their storage positions using the locking mechanisms 13. Advantageously, in the solution of the management of a fleet of vehicles, said elements and 19 may be respectively identical to the electrical connection elements to the circuit for electrical recharging of the battery and/or to the connecting elements to the battery cooling circuit carried by the vehicles. Moreover, the carriage makes it possible to position the battery, which eliminates actuators required to carry out the connections.

Each actuating tool 14 fulfils the principal function of maneuvering in order to lock and/or unlock a battery 11 in a storage position inside a storage cell 12 of a storage structure 10. To achieve this, said tool 14 advantageously comprises a standard interface and comprises a specific number of standard and modular components in order to produce a tool capable of operating on all types of battery and all motor vehicles. Such an actuating tool 14 is also known by its English term “toolbox”.

On the other hand, certain storage cells 12 of the storage structure may be provided with locking mechanisms (not shown) designed to move an actuating tool 14 between a locked state, spatially immobilizing said actuating tool inside the storage cell in a storage position, said locking mechanism now cooperating with said actuating tool and no longer a battery, and an unlocked state spatially releasing the tool 14 from its storage position.

Finally it is possible to provide that the exchange means may comprise two separate lifting devices 15, each carrying an associated actuating tool 14. The exchange means are thus able to dismantle a discharged battery on a vehicle using one of the two devices 15 whilst the other already comprises a charged battery to be mounted on the vehicle as a substitute for the dismantled battery. It suffices, for example, to provide a pivoting of a carriage of the displacement element 17, for example by an angle of 180 degrees, which further permits the time required for the exchange cycle to be reduced.

It should be made clear that the exchange means could have a reverse configuration between the X- and Y-axes, which would correspond to storage which is no longer in the direction of the vehicle but perpendicular to this direction.

Finally, the disclosed solution easily achieves the desired object and has the following advantages:
simple management of the different types of battery in the exchange stations,
assurance that the integrity of each battery is respected during the entire exchange cycle,
simple and cost-effective implementation,
possible standardization of the handling interfaces,
the possibility of charging [sic] different actuating tools 14 according to the types of battery and/or types of locking mechanism,
ensuring the correct mounting of the battery in the vehicle and in the cell.

It should be noted that a further solution for the management of batteries might consist in transporting each battery dismantled from a vehicle by being arranged on a pallet, also called a “supporting platform”. At the time of dismantling, the battery would be deposited on the supporting platform. Then the assembly formed by the battery and the supporting platform would be displaced to the storage structure where said assembly would be installed in a storage cell. The assembly formed by the supporting platform and the battery supported thereby would be deposited from the front into the storage cell until it rests on bearing elements forming part of the lower part of said cell. Thus, in the storage position in the cell, the battery would always rest on the supporting platform which would be designed to facilitate the subsequent handling of the battery. The main drawback of this solution would be in the requirement to provide storage cells with large dimensions to be able to store the supporting platform, in addition to the battery itself, involving at the same time an equivalent loss of space. The preferred solution does not have this drawback.

1. A method for the installation and/or removal of a battery for supplying power to an electric drive motor of an electric or hybrid motor vehicle in/from a storage cell of a battery storage structure, said method comprising:
actuating a locking mechanism with which the storage cell is provided in order to move said locking mechanism between a locked state spatially immobilizing the battery inside the storage cell, said locking mechanism cooperating with said battery in a storage position, and an unlocked state spatially releasing the battery from its storage position.

2. The method as claimed in claim 1, wherein said actuating comprises maneuvering, with an actuating tool, the locking mechanism of the storage cell from below the storage cell.

3. The method as claimed in claim 2, wherein said actuating comprises lifting the actuating tool supporting the battery during the transport thereof from the storage cell.

4. The method as claimed in claim 1, wherein said actuating comprises tensioning the locking mechanism to obtain a disengagement of the locking mechanism, then a rotating at least one lock to obtain the locking and/or unlocking.

5. A storage structure for batteries for supplying power to an electric drive motor an electric or hybrid motor vehicle, said storage structure comprising a plurality of storage cells, each capable of housing a battery, wherein each storage cell comprises a locking mechanism capable of moving between a locked state spatially immobilizing the battery inside the storage cell, said locking mechanism cooperating with said battery in a storage position, and an unlocked state spatially releasing the battery from its storage position.

6. The structure as claimed in claim 5, wherein the storage cells are organized in rows and columns, the cells of one row being mobile along said row.

7. A method for exchanging a battery for supplying power to an electric drive motor of an electric or hybrid motor vehicle, said method comprising a method for the installation and a method for the removal of a battery according to claim 1.

8. The method for exchanging as claimed in claim 7, comprising mounting and/or dismantling a battery on a vehicle, said mounting and/or dismounting comprising actuating a locking mechanism with which the vehicle is provided in order to move said locking mechanism between a locked state fixing the battery to the vehicle and an unlocked state releasing the battery from the vehicle.

9. The method for exchanging as claimed in claim 8, further comprising transferring an actuating tool of the locking mechanisms, with which the vehicle and storage cells are provided, between the storage structure and a zone for mounting and/or dismantling the battery on a vehicle.

10. An exchange station for a battery for supplying power to an electric drive motor of an electric or hybrid motor vehicle, said exchange station comprising at least one storage structure as claimed in claim 5.

11. The exchange station as claimed in claim 10, comprising at least one actuating tool for maneuvering the locking mechanism of the storage cells from below and fixed to a lifting device and, for supporting the battery during the transport thereof from the storage cell.

12. The exchange station as claimed in claim 11, wherein the lifting device is mounted on a displacement element configured to translate the lifting device in at least one direction or in two perpendicular directions.

13. A management method for a fleet of electric or hybrid motor vehicles, said method comprising at least one exchange of batteries for supplying power to electric drive motors of vehicles of the fleet implemented by applying an exchange method as claimed in claim 7.

14. The management method as claimed in claim 13, wherein the vehicles of the fleet are configured so that the locking mechanisms with which they are provided are maneuvered by the same actuating tool as that which maneuvers the locking mechanisms of the storage cells of the storage structure.

15. A management system for a fleet of electric or hybrid motor vehicles, comprising a plurality of exchange stations as claimed in claim 10.

16. The management system as claimed in claim 15, wherein the vehicles of the fleet are configured so that the locking mechanisms with which the vehicles are provided are identical to the locking mechanisms which all or some of the storage cells of the storage structures of the exchange stations comprise.

17. The management system as claimed in claim 15, wherein the connection elements to an electrical battery recharging circuit and/or connecting elements to a battery cooling circuit, with which each storage cell of the storage structure is provided, are respectively identical to the electrical connection elements of the battery and/or to the connecting elements to the battery cooling circuit carried by the vehicles.
